(19) United States
(12) Patent Application Publication
(10) Pub. No.: US 2016/0189218 A1
(43) Pub. Date: Jun. 30, 2016

(54) SYSTEMS AND METHODS FOR SPONSORED SEARCH AD MATCHING

(71) Applicant: Yahoo, Inc., Sunnyvale, CA (US)

(72) Inventor: Nagaraj Kota, Sunnyvale, CA (US)

(21) Appl. No.: 14/586,199

(22) Filed: Dec. 30, 2014

(51) Int. Cl. G06Q 30/02; G06F 17/30

(52) U.S. Cl. CPC G06Q 30/0256; G06F 17/30864; G06F 17/30321; G06Q 30/0275

(57) ABSTRACT

Systems and methods for building a search index for query recommendation and ad matching are disclosed. The system accesses a query-URL graph and extracts a subgraph related to an ad campaign. The subgraph is annotated according to desired criteria. The sub graph is reversed and the reversed annotated subgraph is ranked to find nodes of importance. The nodes of importance are then used to build a preference vector which is used to find a stationary distribution of the sub graph. A plurality of random walks of the sub graph is performed to build a corpus of words. The corpus of words are input into a language model to learn associations, from which the top query terms associated with an ad campaign are found and indexed. The index is then inverted for recommending ads for received query terms.

### BACKGROUND

1. Technical Field

The disclosed embodiments are related to Internet advertising and more particularly to systems and method for sponsored search ad matching and building an index for ad matching and suggesting queries for bidding in a sponsored search marketplace.

2. Background

Internet advertising is a multi-billion dollar industry and is growing at double-digit rates in recent years. It is also the major revenue source for internet companies such as Yahoo!® that provide advertising networks that connect advertisers, publishers, and Internet users. As an intermediary, these companies are also referred to as advertiser brokers or providers. New and creative ways to attract attention of users to advertisements (“ads”) or to the sponsors of those advertisements help to grow the effectiveness of online advertising, and thus increase the growth of sponsored and organic advertising. Publishers partner with advertisers, or allow advertisements to be delivered to their web pages, to help pay for the published content, or for other marketing reasons.

Search engines assist users in finding content on the Internet. In the search ad marketplace, ads are displayed to a user alongside the results of a user's search. Ideally, the displayed ads will be of interest to the user resulting in the user clicking through an ad. In order to increase the likelihood of displaying an ad to a user, an advertiser may bid on multiple keywords for displaying their ad, rather than a single keyword. While an advertiser may be able to easily identify keywords for bidding based on their knowledge of the market, other keywords may escape the advertiser. These keywords represent a lost opportunity for the advertiser to display their ad to an interested user, as well as a lost sales opportunity for the ad broker.

Because the search provider often has the most information regarding keyword searches and user behavior, they are often the best situated to identify keywords that may otherwise be overlooked. To help the advertiser, and to increase their search ad marketplace, brokers in the past have developed systems for recommending keywords to advertisers. These systems may be relatively simple, such as a broker manually entering words they believe to be related, to more advanced techniques such as query-log mining, based on related searches, co-biddedness, based on advertisers bidding on similar keywords, and search uniform resource locator (URL) overlap, in which different keywords result in the same set of search URLs.

The described systems are each successful in their own way to suggest keywords to advertisers. However, they do not necessarily capture all of the related keywords that an advertiser may be interested in, or they may suggest some keywords that are actually of little value to the advertiser.

Thus, there exists a technical problem of how to increase the number of keywords to recommend to an advertiser, while maintaining the quality of the recommendations. The particular context of the problem is described herein as a sponsored-search system in which keywords are recommended to an advertiser bidding on keywords. However, the solutions described herein may be readily extended to other database searching and query satisfaction systems.

### BRIEF SUMMARY

It would be beneficial to develop a system for recommending keywords that returned results that may be overlooked by current systems, while limiting the recommendation of keywords having little value to the advertiser. If a larger number of keywords are bid on that are still relevant to the original query, it will increase the opportunities for an advertiser to reach their target audience, while additionally increasing the sales of the ad broker. It would further be beneficial to identify ad impressions to an advertiser that may be related to their bidded terms, without having to actually match their terms.

In one aspect of the disclosure, a method for building a query-advertisement index is described. The method includes accessing a query-URL graph, the graph having query nodes, URL nodes, and edges modeling transition probabilities between nodes; accessing a plurality of ad campaigns, each of the plurality of ad campaigns having associated bidded terms; for each of a plurality of ad campaigns, extracting a subgraph from the query-URL graph, the subgraph comprising query nodes corresponding to the bidded terms of the ad campaign and all nodes within a specified number of steps of the bidded term query nodes; annotating the subgraph to indicate query nodes having characteristic corresponding to a desired criteria; reversing the subgraph; ranking the reversed annotated subgraph to find nodes of importance; constructing a preference vector of important nodes as determined by the ranked reversed annotated subgraph; performing a random walk with restart of the subgraph using the constructed preference vector to obtain a stationary distribution; sampling a plurality of walks from the stationary distribution to build a corpus of graph nodes; providing the corpus to a machine learning model to learn a distributed representation of dense word vectors; computing the top queries for the ad campaign using the dense word vectors; associating each of the plurality of ad campaigns with the top queries for the ad campaign to build an ad campaign to query index; and inverting the ad campaign to query index to create a query-ad campaign index.

In some embodiments, the specified number of steps is three. In some embodiments, the query nodes are search terms, and the edges are one step likely hood of transition from search term to the URL. In some embodiments, the desired criterion is commerce related nodes. In some embodiments, commerce related nodes are URL nodes corresponding to advertisements and query nodes corresponding to bidded terms. In some embodiments, the random walk with restart is a biased forward random walk with restart with the preference vector providing the bias.

In another aspect of the disclosure, a system for building a query-advertisement campaign index is described. The system includes a processor and computer readable storage media in communication with the processor, the computer readable storage media storing instructions that, when executed by the processor cause the system to: access a query-URL graph, the graph having query nodes, URL nodes, and edges modeling transition probabilities between nodes; access a plurality of ad campaigns, each of the plurality of ad campaigns having associated bidded terms; for each of a plurality of ad campaigns: extract a subgraph from the query-URL graph, the subgraph comprising query nodes corresponding to the bidded terms of the ad campaign and all nodes within a specified number of steps of the bidded term query nodes; annotate the subgraph to indicate query nodes having characteristic corresponding to a desired criteria; reverse the subgraph; rank the reversed annotated subgraph to find nodes of importance; construct a preference vector of commercial nodes as determined by the ranked reversed annotated subgraph; perform a random walk with restart of the subgraph using the constructed preference vector to obtain a stationary distribution; sample a plurality of walks from the stationary distribution to build a corpus of graph nodes; provide the corpus to a machine learning model to learn a distributed representation of dense word vectors; compute the top queries for the ad campaign using the dense word vectors; associate each of the plurality of ad campaigns with the top queries for the ad campaign to build an ad campaign to query index; invert the ad campaign to query index to create the query-ad campaign index; and save the query-advertisement campaign index.

In some embodiments, the specified number of steps is three. In some embodiments, the query nodes art search terms and the edges are one step likely hood of transition from search term to the URL. In some embodiments, the desired criteria are commerce related nodes. In some embodiments, the commerce related nodes comprise URL nodes corresponding to advertisements and query nodes corresponding to bidded terms. In some embodiments, the random walk with restart is biased forward random walk with restart with the preference vector providing the bias.

In another aspect of the disclosure, a computer readable storage media is described. The computer readable storage media stores computer executable instructions, that when executed by a processor cause the processor to perform a method including steps to access a query-URL graph, the graph comprising query nodes, URL nodes, and edges modeling transition probabilities between nodes; access a plurality of ad campaigns, each of the plurality of ad campaigns having associated bidded terms; for each of a plurality of ad campaigns: extract a subgraph from the query-URL graph, the subgraph comprising query nodes corresponding to the bidded terms of the ad campaign and all nodes within a specified number of steps of the bidded term query nodes; annotate the subgraph to indicate query nodes having characteristic corresponding to a desired criteria; reverse the subgraph; rank the reversed annotated subgraph to find nodes of importance; construct a preference vector of important nodes as determined by the ranked reversed annotated subgraph; perform a random walk with restart of the subgraph using the constructed preference vector to obtain a stationary distribution; sample a plurality of walks from the stationary distribution to build a corpus of graph nodes; provide the corpus to a machine learning model to learn a distributed representation of dense word vectors; compute the top queries for the ad campaign using the dense word vectors; associate each of the plurality of ad campaigns with the top queries for the ad campaign to build an ad campaign to query index; and invert the ad campaign to query index to create a query-ad campaign index.

In some embodiments, the specified number of steps is three. In some embodiments, the query nodes art search terms and the edges are one step likely hood of transition from search term to the URL. In some embodiments, the desired criteria are commerce related nodes. In some embodiments, the commerce related nodes comprise URL nodes corresponding to advertisements and query nodes corresponding to bidded terms. In some embodiments, the random walk with restart is biased forward random walk with restart with the preference vector providing the bias.

### BRIEF DESCRIPTION OF THE DRAWINGS

FIG. 1 illustrates an exemplary embodiment of a network system suitable for practicing the invention.

FIG. 2 illustrates a schematic of a computing device suitable for practicing the invention.

FIG. 3 illustrates a high level system diagram of a method for building a query-ad campaign index.

FIG. 4 illustrates a flowchart of a method for building an query-ad index.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The claimed subject matter is related to monetization of sponsored search advertising. Various monetization techniques or models may be used in connection with sponsored search advertising, including advertising associated with user search queries, or non-sponsored search advertising, including graphical or display advertising. In an auction type online advertising marketplace, advertisers may bid in connection with placement of advertisements, although other factors may also be included in determining advertisement selection or ranking. Bids may be associated with amounts advertisers pay for certain specified occurrences, such as for placed or clicked on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

The disclosed subject matter further relates to systems and methods for recommending search queries for bidding to an advertiser and for building an index for recommending search queries. The systems and methods are able to recommend queries that may not be found using conventional techniques. It is also able to bias the recommended queries to those that have commercial value. A query is more valuable to an advertiser if it has a greater probability of leading to a commercial interaction. The system may be modified using criteria other than commercial value, such as demographic, temporal, or geographic attributes. In the system for building a query-advertisement index, a query-URL graph, such as a search history log may be assessed and for a given advertisement campaign, a subgraph containing related queries is found. The relation may be defined as all queries within a predetermined number of steps, such as three or five steps. The resulting subgraph is annotated to indicate nodes associated with criteria, such as commercial value. The subgraph is then reversed and ranked to construct a preference vector. The preference vector may then be used in a biased forward random walk with restart of a query-URL graph to obtain a stationary distribution. The query-URL graph may be the original query-URL graph, or it may be the subgraph extracted from the query-URL graph. A corpus of graph nodes is then found from the stationary distribution by sampling a plurality of random walks. The corpus is then processed in a machine learning model to learn a distributed representation of dense vectors resulting in a unified query/ad representation. The top queries for the ad campaign can then be found based on the unified query/ad representation. Once the top queries are found, they are associated with the ad campaign to build an ad campaign to query index. The index is then inverted to create a query-ad campaign index.

When a user enters a search query at a client device, the search query is sent to a search engine and the search engine may return search results related to the query for display on a search results page at the client device. Additionally, the query may be sent to an ad network, which may then access the query-ad campaign index and find an advertisement for display on the search result page at the client device. The system may also find query terms related to an advertisement campaign, and recommend those query terms to an advertiser.

### Ad Network

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

### Network

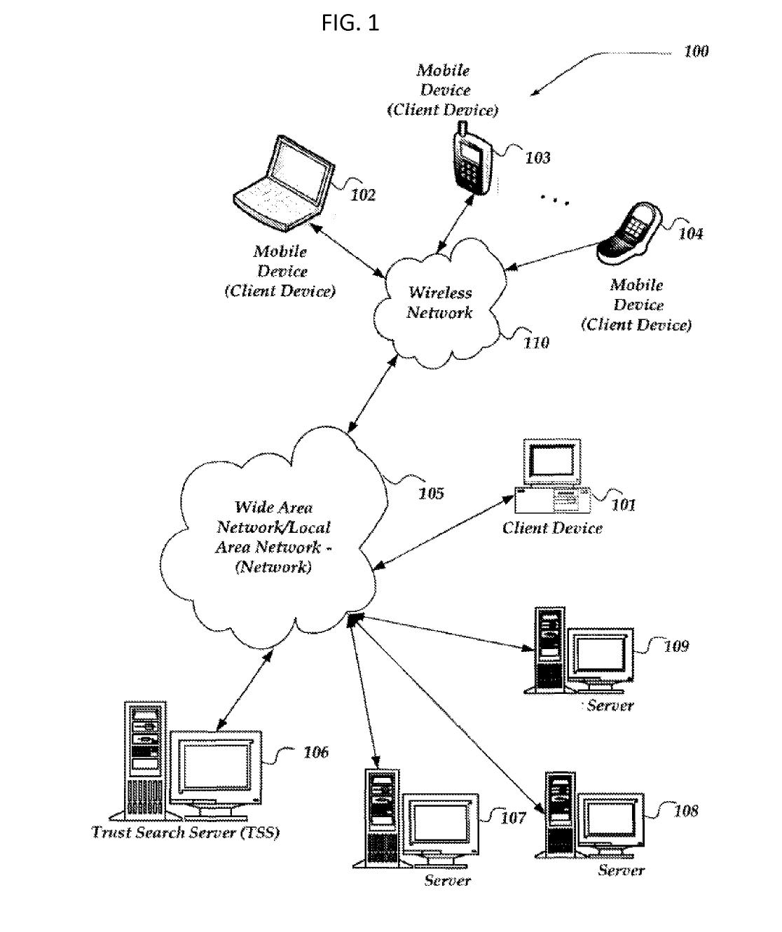

FIG. 1 is a schematic diagram illustrating an example embodiment of a network 100 suitable for practicing the claimed subject matter. Other embodiments may vary, for example, in terms of arrangement or in terms of type of components, and are also intended to be included within claimed subject matter. Furthermore, each component may be formed from multiple components. The example network 100 of FIG. 1 may include one or more networks, such as local area network (LAN)/wide area network (WAN) 105 and wireless network 110, interconnecting a variety of devices, such as client device 101, mobile devices 102, 103, and 104, servers 107, 108, and 109, and search server 106.

The network 100 may couple devices so that communications may be exchanged, such as between a client device, a search engine, and an ad server, or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

### Computing Device

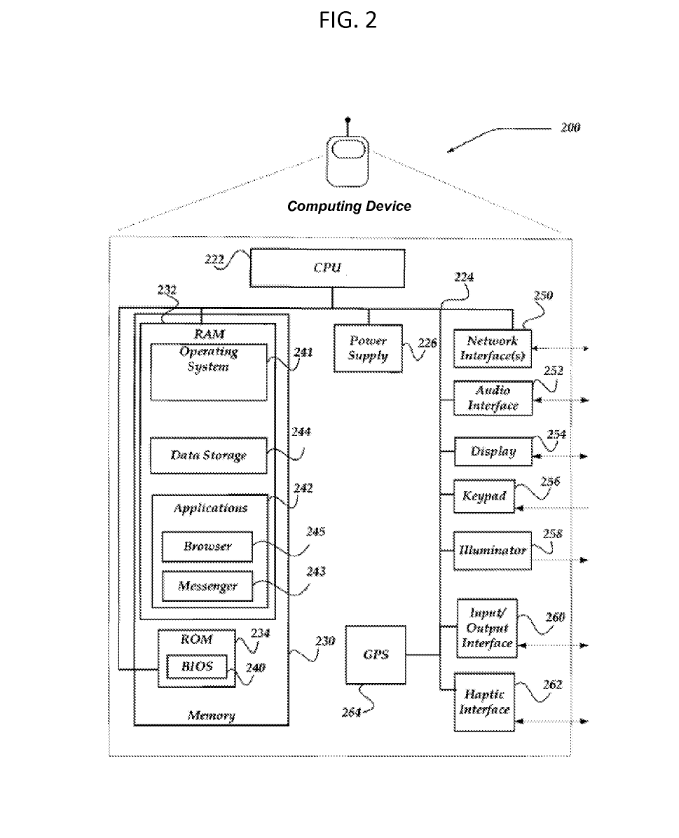

FIG. 2 shows one example schematic of an embodiment of a computing device 200 that may be used to practice the claimed subject matter. The computing device 200 includes a memory 230 that stores computer readable data. The memory 230 may include random access memory (RAM) 232 and read only memory (ROM) 234. The ROM 234 may include memory storing a basic input output system (BIOS) 230 for interfacing with the hardware of the client device 200. The RAM 232 may include an operating system 241, data storage 244, and applications 242 including a browser 245 and a messenger 243. A central processing unit (CPU) 222 executes computer instructions to implement functions. A power supply 226 supplies power to the memory 230, the CPU 222, and other components. The CPU 222, the memory 230, and other devices may be interconnected by a bus 224 operable to communicate between the different components. The computing device 200 may further include components interconnected to the bus 224 such as a network interface 250 that provides an interface between the computing device 200 and a network, an audio interface 252 that provides auditory input and output with the computing device 200, a display 254 for displaying information, a keypad 256 for inputting information, an illuminator 258 for displaying visual indications, an input/output interface 260 for interfacing with other input/output devices, haptic feedback interface 262 for providing tactile feedback, and a global positioning system 264 for determining a geographical location.

### Client Device

A client device is a computing device 200 used by a client and may be capable of sending or receiving signals via the wired or the wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features and need not contain all of the components described above in relation to a computing device. Similarly, a client device may have other components that were not previously described. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

### Servers

A server is a computing device 200 that provides services, such as search services, indexing services, file services, email services, communication services, and content services. Servers vary in application and capabilities and need not contain all of the components of the exemplary computing device 200. Additionally, a server may contain additional components not shown in the exemplary computing device 200. In some embodiments a computing device 200 may operate as both a client device and a server.

An “ad server” comprises a server that stores online advertisements for presentation to users. “Ad serving” refers to methods used to place online advertisements on websites, in applications, or other places where users are more likely to see them, such as during an online session or during computing platform use, for example.

### Graphs

The claimed subject matter uses traditional computer science concepts such as graphs. Graphs are a technique for representing data in the form of nodes and their relationships in the form of interconnected edges. One of ordinary skill in the art would be familiar with traditional graph traversal and manipulation. For example, one would be familiar with traversal techniques such as a depth-first search, a breadth-first search, random walks, etc. and with manipulations such as graph inversion or reversal.

One of ordinary skill in the art would recognize traditional graph algorithms such as finding a path between two nodes, like depth-first search and breadth-first search, and techniques for finding the shortest path from one node to another. Furthermore, algorithms for ranking graph nodes are well known in the art, such as PageRank, Topic-Sensitive PageRank, and other algorithms.

Model Language Relationships with Non Linear Programming (NLP)

Language models play an important role in many NLP applications, especially in information retrieval. Traditional language model approaches represent a word as a feature vector using a one-hot representation - the feature vector has the same length as the size of the vocabulary, where only one position that corresponds to the observed word is switched on. However, this representation suffers from data sparsity. For words that are rare, corresponding parameters will be poorly estimated.

Inducing low dimensional embeddings of words by neural networks has significantly improved the state of the art in NLP. Typical neural network based approaches for learning low dimensional word vectors are trained using stochastic gradient via back propagation. Historically, training of neural network based language models has been slow, which scales as the size of the vocabulary for each training iteration. Scalable continuous Skip-gram deep learning model for learning word representations has shown promising results in capturing both syntactic and semantic word relationships in large news articles data.

The Skip-gram model is designed to train a model that can find word representations that are capable of predicting the surrounding words in a document. The model accounts for both query co-occurrence and context co-occurrence. In particular, queries that co-occur often or frequently have similar contexts (i.e., surrounding queries) will be projected nearby in the new vector space.

The training objective for the skip-gram model is stated as follows. Assume a sequence of words w₁, w₂, w₃, . . . , w_{T} in a document used for training, and denote by V the vocabulary, a set of all words appearing in the training corpus. The algorithm operates in a sliding window fashion, with a center word w and k surrounding words before and after the central word, which is referred to as context c. It is possible to use a window of different size. It may be useful to have a sequence of words forming a document in which each word within the document is related to one another. The window may then be each document such that all terms in a sequence are considered related, rather than just k surrounding words. This may be accomplished by using an infinite window for each document making up the training data. The parameters θ to be learned are the word vectors v for each of the words in the corpus.

At each step of the sliding window process the conditional probabilities of context are considered given the word [symbol] (c|w). For a single document, the parameters θ that maximize the document corpus probability, given as

$$arg max {\prod }_{t = 1}^{T} {\prod }_{- k \leq j \leq j \neq t} ℙ ( {w}_{t + j} \vert {w}_{t} \text{;} θ )$$

Considering that training data may contain many documents, the global objective may be written as

$$arg max {\prod }_{( w , c ) ∈ D}^{T} ℙ ( c \vert w \text{;} θ )$$

where D is the set of all word and context pairs in the training data.

Modeling the probability [symbol] (c|w, θ) may be done using a soft-max function, as is typically used in the neural-network language models. The main disadvantage of the presented solution is that it is computationally expensive, for example, in terms of a required number of processor cycles or memory storage requirements. The term [symbol] (c|w, θ) is very expensive to compute due to the summation over the entire vocabulary, therefore making the training complexity proportional to size of the training data that may contain hundreds of thousands of distinct words.

Significant training speed-up may be achieved when using a hierarchical soft-max approach. Hierarchical soft-max represents the output layer (context) as a binary tree with |V| words as leaves, where each word w may be reached by a path from the root of the tree. If n(w,j) is the j-th node on that path to word w, and L(w) is the path length, the hierarchical soft-max defines probability [symbol] (w|wᵢ) as

$$ℙ ( w \vert {w}_{i} ) = {\prod }_{j = 1}^{L ( w ) - 1} σ ( {v}_{n ( w , j )}^{T} \cdot {v}_{{w}_{i}} )$$

Where σ(x)=1/(1+exp(−x)). Then, the cost of computing the hierarchical soft-max approach is proportional to log |V|. In addition, the hierarchical soft-max skip-gram model assigns one representation v_{w} to each word, and one representation vₙ for every inner node n of the binary tree, unlike the soft-max model in which each word had context and word vectors v_{c} and v_{w}, respectively.

In the examples that follow, this general approach may be used with sequences of words derived queries and related URLs. The combination of a large number of word sequences together forms a corpus that may be used to train a model. Other approaches for training a model that finds word representations that are capable of predicting the surrounding words in a document may be used. For example, Word2vec, a popular open-source software, is readily available for training low dimensional word vectors. However, previous work, such as Word2vec, has focused in capturing word relationships with respect to everyday language. As such, the Word2vec tool is trained using a corpus of common phrases, such as those found on Wikipedia.

### Building a Query-Ad Index

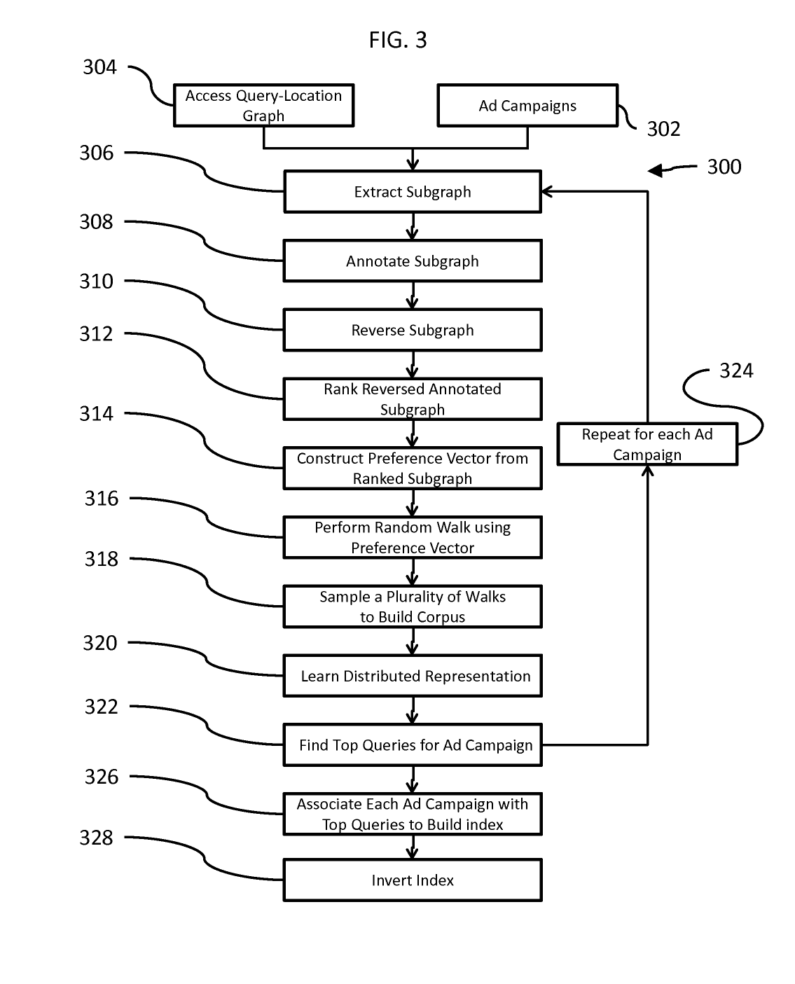

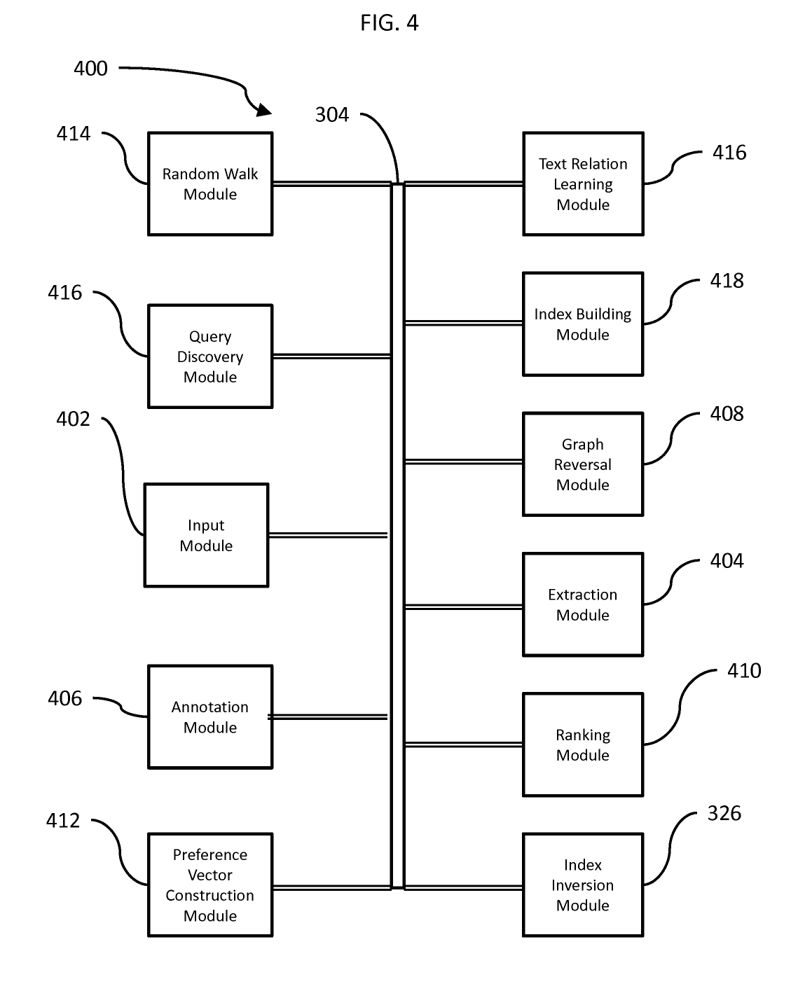

FIG. 3 illustrates a high level flowchart of a method 300 for building a query-ad index. FIG. 4 illustrates a high level system diagram of a system of modules suitable for implementing the method 300 of FIG. 3. The method of FIG. 3 will be described in relation to the system of FIG. 4. The system 400 may be executed as hardware or software modules on a computing device as shown in FIG. 2, for example, or as a combination of hardware and software modules. The modules may be executable on a single computing device or a combination of modules may each be executable on separate computing devices interconnected by a network. For example, a single server, such as server 109 may execute each of the modules, accessing a query-URL from a networked device and outputting the query-ad campaign index to an ad network. In another example, a combination of servers such as server 109, server 108, and server 107, could operate together with each server executing a module. Server 107 may receive session and query data from a search server such as Trust Search Server 106. Server 107 may then output a sub-graph to server 108 over network 105. Server 108 may generate the query-ad campaign index and output it to server 109. Server 109 may then receive a query over network 105 from a client device 102 and recommend ad campaigns for serving an advertisement based on the query over network 105. FIG. 4 illustrates a high level diagram of the system 400 with each module component being connected directly to a central communication bus 304, but they need not be. For example, each module could be connected directly to another module to communicate between the modules.

The method begins at block 304 by accessing a query-URL graph. For example, the input module 402 may receive data representing the query-URL graph. The query-URL graph includes nodes corresponding to queries, nodes corresponding to URLs, and edges that model one step transition probabilities between nodes. URLs may correspond to informational content, an advertisement, a shopping web site, or other content. The one step transition probability reflects the probability that a user will click on a URL associated with a query. For example, if a user entered the query “operating system,” URLs corresponding to links to Windows, Linux, and OS X may be returned. Depending on the popularity of the operating system, the user may have a greater probability to click on a link to that operating system. The one step transition probability would reflect that probability. The data may be received in a single session, or it may be received periodically. The data may be received over a network, it may be stored locally, or it may be input through an input/output interface.

In block 302 a plurality of ad campaigns are accessed. Similar to accessing the query-URL graph, the ad campaigns may be represented by data received by input module 402. The ad campaigns may be accessed individually, or in a group. An ad campaign may be a campaign for which an advertiser is bidding on a group of keywords and has associated ads for display when those keywords are entered as queries.

A subgraph is then extracted from the query-URL graph in block 306. The subgraph may be extracted using the extraction module 404. The subgraph is extracted based on the query terms associated with an ad campaign. For example, if an ad campaign bidded on the query terms “baseball,” “mitt,” “diamond,” “bat,” and “base,” the subgraph would be based on these query terms. For each query term, there is a related URL that is a search result associated with that query term. For example, the term “bat” could lead to a link about baseball, a link about manufacturing baseball bats, and a link about the mammals. Each of these links would be considered to be one step away from the query term. For each URL, there is at least one query term that leads to that URL. For example, the link about baseball may have query terms of baseball, games, homerun, and stadium that led to the link. Each of these query terms would be considered a second step and would be included in a subtree that included second steps. Each of these query terms would have associated URLs that would be considered a third step and so on. The subgraph may be of any number of steps, but three steps and five steps are typical. The proceeding example is used as a simplified example. The actually data contained in a query search large is much larger, containing far more results for each query.

In block 308 the subgraph is annotated to reflect desired criteria. Annotation module 406 may be used to annotate the subgraph. The desired criteria may be commerciality in which case bidded query terms, commercial queries, queries that lead to an ad click, and ad landing URLs may be annotated to reflect their commercial usage. Other criteria may be used and embodiments are not limited to bidded query terms, advertisements, or commercial criteria. For example, if demographics of the query-URL graph are known, they may be used to target a particular demographic.

The subgraph is then reversed in block 310. Graph reversal module 408 may be used to reverse the graph. In a graph reversal, the edges are reversed, such that query nodes having edges leading to URLs are reversed, such that the edges, and their corresponding transition probabilities, lead from URLs to query nodes.

The reversed subgraph is then ranked in block 312 to find nodes of importance as reflected in the criteria for annotating the subgraph. The ranking may be performed by ranking module 410. The ranking may be any standard ranking algorithm as known by those of skill in the art. The ranking algorithm results in a rank for each of the nodes in the subgraph taking into account the annotations.

The resulting ranked, reversed, annotated subgraph is then used to construct a preference vector of nodes in block 314. The preference vector includes the original source query terms, and/or the top important annotated nodes as determined by ranked reversed subgraph. The preference vector biases future rankings toward preferred nodes as indicated in the preference vector. The preference vector may be constructed by the preference vector construction module 412.

In block 316, the subgraph is ranked using the preference vector constructed in block 314 to obtain a stationary distribution. The subgraph may be ranked using a biased forward random walk with restart. The stationary distribution shows the nodes of greatest importance taking into account the bias of the preference vector. If the preference vector was constructed using commercial criteria, the stationary distribution will show the nodes of greatest importance relative to commercial use. Random walk module 414 may be used to perform the ranking of the subgraph with the preference vector.

In block 318, a random walk is sampled from the stationary distribution and the text associated with each node is saved as a string. For example, a string may contain queries, URLs, queries, URL, and queries. This sampling process is repeated to build a corpus of strings. The random walk sampling may be performed using the random walk module 414.

The corpus of strings is then input into text relation learning module 416 to learn relationships between the words in the corpus as shown in block 320. The text relation learning module may use the Skip-gram model described previously with each document corresponding to string derived from the random walk sample. In other embodiments, all of the strings may be input as a single document and Skip-gram model may find relationships in the single document. The result of the machine learning module is a distributed representation of dense vectors, where related words are mapped to a similar position in the vector space.

From the distributed representation of dense vectors, the top queries for the ad campaign may be found in block 322. The top queries for an ad campaign may be found by finding the nearest neighbors of bidded query terms associated with the ad campaign. The resulting top queries may be those found to be nearest the bidded terms. Query discovery module 416 may be utilized to determine the top queries for an ad campaign.

As shown by block 324, blocks 306 through 322 are repeated for each ad campaign to build an index of ad campaigns and top query terms associated with the ad campaign as shown in block 326. Index building module 418 may receive each of the top query terms and associate them with the ad campaign that produced the query terms. This index may be used to recommend query terms for a given ad campaign.

In block 328, the index produced in block 326 is inverted from an ad to query index, to a query to ad index. Thus instead of giving queries when an ad campaign is input, the inverted index gives related ad campaigns when a query term is input. When a user enters a query term in a search engine, the index will identify ad campaigns relevant to the query term. The ad campaigns may then be given the opportunity to serve an ad, or to bid on the query term that identified their ad campaign.

The system and methods described previously provide recognizable benefits over conventional techniques for recommending query terms and finding ads to serve based on received query. In particular, the described system and methods provides for a system that biases queries so that they are of greater value to a user such as an advertiser. The system captures user intent, such as commercial use, while maximizing coverage. The model provides a flexible method, allowing fine tuning to account for varying criteria for various tasks of critical interest to search engine companies (e.g., rewrite specialization, rewrite generalization, optimization of improving bid term coverage and click-through rates). The method is able to be biased to most any criteria of interest to an advertiser such as demographics, location, and commercial use. The system and methods further provide an opportunity to increase relevant ad-coverage and improve click yields leading to increased revenue per search.

From the foregoing, it can be seen that the present disclosure provides systems and methods for ad-matching in sponsored search that provides wide coverage while targeting criteria that may be sparsely represented. While various embodiments have been described above, it should be understood that they have been presented by way of example only, and not limitation. It will be apparent to persons skilled in the relevant arts that various changes in form and details can be made therein without departing from the spirit and scope of the invention. Thus, the breadth and scope of the present invention should not be limited by any of the above-described exemplary embodiments, but should be defined only in accordance with the following claims and their equivalents.

1. A method for building a query-advertisement index, the method comprising:
accessing a query-uniform resource locator graph, the graph comprising query nodes, uniform resource locator (URL) nodes, and edges modeling transition probabilities between nodes;
accessing a plurality of ad campaigns, each of the plurality of ad campaigns having associated bidded terms;
for each of a plurality of ad campaigns:
extracting a subgraph from the query-URL graph, the subgraph comprising query nodes corresponding to the bidded terms of the ad campaign and all nodes within a specified number of steps of the bidded term query nodes;
annotating the subgraph to indicate query nodes having characteristic corresponding to a desired criteria;
reversing the subgraph;
ranking the reversed annotated subgraph to find nodes of importance;
constructing a preference vector of important nodes as determined by the ranked reversed annotated subgraph;
performing a random walk with restart of the subgraph using the constructed preference vector to obtain a stationary distribution;
sampling a plurality of walks from the stationary distribution to build a corpus of graph nodes;
providing the corpus to a machine learning model to learn a distributed representation of dense word vectors;
computing the top queries for the ad campaign using the dense word vectors;
associating each of the plurality of ad campaigns with the top queries for the ad campaign to build an ad campaign to query index; and
inverting the ad campaign to query index to create a query-ad campaign index.

2. The method of claim 1, wherein the specified number of steps is three.

3. The method of claim 1, wherein the query nodes comprise search terms and the edges are one step likely hood of transition from search term to the URL.

4. The method of claim 1, wherein the desired criteria comprises commerce related nodes.

5. The method of claim 4, wherein commerce related nodes comprises URL nodes corresponding to advertisements and query nodes corresponding to bidded terms.

6. The method of claim 1, wherein the random walk with restart is a biased forward random walk with restart with the preference vector providing the bias.

7. A system for building a query-advertisement campaign index, the system comprising a processor and computer readable storage media in communication with the processor, the computer readable storage media storing instructions that, when executed by the processor cause the system to:
access a query-URL graph, the graph comprising query nodes, URL nodes, and edges modeling transition probabilities between nodes;
access a plurality of ad campaigns, each of the plurality of ad campaigns having associated bidded terms;
for each of a plurality of ad campaigns:
extract a subgraph from the query-URL graph, the subgraph comprising query nodes corresponding to the bidded terms of the ad campaign and all nodes within a specified number of steps of the bidded term query nodes;
annotate the subgraph to indicate query nodes having characteristic corresponding to a desired criteria;
reverse the subgraph;
rank the reversed annotated subgraph to find nodes of importance;
construct a preference vector of commercial nodes as determined by the ranked reversed annotated subgraph;
perform a random walk with restart of the subgraph using the constructed preference vector to obtain a stationary distribution;
sample a plurality of walks from the stationary distribution to build a corpus of graph nodes;
provide the corpus to a machine learning model to learn a distributed representation of dense word vectors;
compute the top queries for the ad campaign using the dense word vectors;
associate each of the plurality of ad campaigns with the top queries for the ad campaign to build an ad campaign to query index;
invert the ad campaign to query index to create the query-ad campaign index; and
save the query-advertisement campaign index.

8. The system of claim 7, wherein the specified number of steps is three.

9. The system of claim 7, wherein the query nodes comprise search terms and the edges are one step likely hood of transition from search term to the URL.

10. The system of claim 7, wherein the desired criteria comprises commerce related nodes.

11. The system of claim 10, wherein the commerce related nodes comprise URL nodes corresponding to advertisements and query nodes corresponding to bidded terms.

12. The system of claim 7, wherein the random walk with restart is biased forward random walk with restart with the preference vector providing the bias.

13. A computer readable storage media storing computer executable instructions, that when executed by a processor cause the processor to perform a method comprising:
access a query-URL graph, the graph comprising query nodes, URL nodes, and edges modeling transition probabilities between nodes;
access a plurality of ad campaigns, each of the plurality of ad campaigns having associated bidded terms;
for each of a plurality of ad campaigns:
extract a subgraph from the query- URL graph, the subgraph comprising query nodes corresponding to the bidded terms of the ad campaign and all nodes within a specified number of steps of the bidded term query nodes;
annotate the subgraph to indicate query nodes having characteristic corresponding to a desired criteria;
reverse the subgraph;
rank the reversed annotated subgraph to find nodes of importance;
construct a preference vector of important nodes as determined by the ranked reversed annotated subgraph;
perform a random walk with restart of the subgraph using the constructed preference vector to obtain a stationary distribution;
sample a plurality of walks from the stationary distribution to build a corpus of graph nodes;
provide the corpus to a machine learning model to learn a distributed representation of dense word vectors;
compute the top queries for the ad campaign using the dense word vectors;
associate each of the plurality of ad campaigns with the top queries for the ad campaign to build an ad campaign to query index; and
invert the ad campaign to query index to create a query-ad campaign index.

14. The computer readable storage media of claim 13, wherein the specified number of steps is three.

15. The computer readable storage media of claim 13, wherein the specified number of steps is three.

16. The computer readable storage media of claim 13, wherein the query nodes comprise search terms and the edges are one step likely hood of transition from search term to the uniform resource locator.

17. The computer readable storage media of claim 13, wherein the desired criteria comprises commerce related nodes.

18. The computer readable storage media of claim 17, wherein the commerce related nodes comprise URL nodes corresponding to advertisements and query nodes corresponding to bidded terms.

19. The computer readable storage media of claim 13, wherein the random walk with restart is biased forward random walk with restart with the preference vector providing the bias.
